(19) United States
(12) Patent Application Publication
(10) Pub. No.: US 2026/0185903 A1
(43) Pub. Date: Jul. 2, 2026

(54) EDGE COMPUTING SYSTEM AND METHOD FOR ANALYZING ANTI-DRONE SYSTEM

(71) Applicant: Electronics and Telecommunications Research Institute, Daejeon (KR)

(72) Inventors: Jaein Kim, Daejeon (KR); KICHEOUL WANG, Daejeon (KR); Chorwon Kim, Daejeon (KR); HEE DO KIM, Daejeon (KR)

(21) Appl. No.: 19/437,126

(22) Filed: Dec. 30, 2025

(30) Foreign Application Priority Data
Dec. 30, 2024 (KR) 10-2024-0200890
Sep. 30, 2025 (KR) 10-2025-0143106

(51) Int. Cl. G01M 99/00; G06F 40/103; G06F 40/20

(52) U.S. Cl. CPC G01M 99/00; G06F 40/103; G06F 40/20

(57) ABSTRACT

An edge computing device includes: a physical communication interface connected to a communication interface of an anti-drone product; and a text data collector configured to connect to the anti-drone product, to receive output data from the connected anti-drone product, to extract text data from the received output data of the anti-drone product, and to convert the extracted text data into data in a preset data format.

### CROSS-REFERENCE TO RELATED APPLICATION

This application claims priority under 35 U.S.C § 119 to Korean Patent Application No. 10-2024-0200890 filed in the Korean Intellectual Property Office on Dec. 30, 2024, and Korean Patent Application No. 10-2025-0143106 filed in the Korean Intellectual Property Office on Sep. 30, 2025, the entire contents of which are hereby incorporated by reference.

### BACKGROUND

### 1. Technical Field

The present disclosure relates to an edge computing system for analyzing an anti-drone system, and more particularly, to an edge computing system for analyzing an anti-drone system, which can be connected to an anti-drone product in order to objectively evaluate functions and performance of the anti-drone product, automatically extract objective data, and selectively transmit main analysis data to an analysis server.

### 2. Related Art

Anti-drone products are products that detect, identify, and neutralize drones, and mainly aim at, when unauthorized drones fly or drones enter a drone-restricted area, detecting, identifying, and neutralizing the drones.

Globally, since standardized analysis systems have not been established for the detection, identification, and neutralization as main functions of anti-drone products, objective evaluation for functions and performance of products claimed by each manufacturer has not been made.

However, each country has established its own standard for testing and analyzing anti-drone products to perform a partial analysis test.

In Republic of Korea, the National Counterterrorism Center is testing and analyzing anti-drone products, but there are several limitations in objective test and analysis of the products itself.

The test and analysis procedure for anti-drone products first requires a product modification task in a process of outputting various data of the anti-drone products to an analysis server.

For example, when the analysis server collects specific data by using an Ethernet protocol, radar equipment needs to manually transmit data of latitude, longitude, altitude, speed, and the like of a detected drone to the analysis server in order to use the data for test and analysis.

That is, in response to the test and analysis performed by the analysis server, it is necessary to select data required by the analysis server to generate a data frame, and transmit the generated data frame using a protocol used by the analysis server.

In addition, it is necessary to manually input and transmit information on environments where detection/identification/neutralization equipment(radars, RF scanners, EO/IR cameras, GPS jammers, etc.) is operated. For example, it is necessary to separately transmit latitude, longitude, altitude, direction, etc., in which anti-drone products are operated.

When the analysis server has no function of receiving the environment information, the environment information is transmitted manually or by radio and is used for test and analysis.

In such a process, a fatal problem of lacking objectivity may occur when the data of the anti-drone products is provided to the test analysis server.

Performing a product modification task for transmitting required data frames to the analysis server in order to test and analyze a finally completed anti-drone product may cause changes to a test object.

When a product is changed by modifying codes in the anti-drone product, a procedure itself may impair objectivity. In addition, since modifying the anti-drone product causes an additional task for a product manufacturer, ease of test and analysis may be reduced.

In addition, manually inputting operating environment information of a product may also impair the objectivity of test and analysis because it includes various human errors.

### SUMMARY

Various embodiments are directed to providing an edge computing system and method that can automatically extract objective data after connecting to an anti-drone product and analyze the anti-drone product by selectively transmitting main analysis data to an analysis server, in order to objectively analyze functions and performance of the anti-drone product.

An object of the present disclosure is to objectively collect data acquired from an anti-drone product without an intervention of a product manufacturer or a tester and without modifying a completed product, to transmit the collected data to an analysis server, and to objectify test analysis on the analysis server through the collection and transmission.

Objects of the present disclosure are not limited to the aforementioned objects, and other objects not described above may be evidently understood by a person having ordinary knowledge in the art from the following description.

An edge computing device according to an aspect of the present disclosure includes: a physical communication interface connected to a communication interface of an anti-drone product; and a text data collector configured to connect to the anti-drone product, to receive output data from the connected anti-drone product, to extract text data from the received output data of the anti-drone product, and to convert the extracted text data into data in a preset data format.

The present disclosure further includes: a database configured to store edge device information including information on the anti-drone product regarding functions according to functional purposes (carrying and identification and neutralization) of the anti-drone product, and network information (reception-side information); and a timestamp acquisition unit configured to acquire a global timestamp value for an anti-drone analysis, wherein the text data collector acquires a global timestamp value of an anti-drone analysis system acquired via GPS or a PTP protocol, matches the global timestamp value to various event data collected during drone detection, identification, and neutralization, and objectively stores time of the data.

The present disclosure further includes an environmental sensor attached to an exterior of the anti-drone product to collect operating data of the anti-drone product during an execution of an anti-drone function and environment data outside the anti-drone product.

The communication interface is provided in a plural number to be connected in parallel to a plurality of anti-drone products, and text data collectors store data collected from the plurality of anti-drone products via respective communication interfaces in an integrated manner based on a global timestamp value.

The present disclosure includes an anti-drone product configured to perform an anti-drone function is provided and the anti-drone product includes: a communication interface configured to communicate with the edge computing device; and an agent configured to copy standard output/standard error log data provided by an operating system (OS) of the anti-drone product according to characteristics of the operating system, and to transmit output data including the log data to the edge computing device via the communication interface.

The anti-drone product is one or more devices among a radar that uses radio waves to detect and track a location, speed, and altitude of a drone, a radio frequency (RF) scanner that detects radio signals between the drone and a controller to ascertain presence of the drone and track a flight direction of the drone, an optical/infrared (EO/IR) camera used to visually confirm and identify a target detected by the radar or the RF scanner, an optical camera, a thermal imaging camera, and an acoustic sensor that senses sound of the drone.

An anti-drone analysis method according to an aspect of the present disclosure includes: connecting an edge computing device to an anti-drone product; receiving, by the edge computing device, output data from the connected anti-drone product; extracting text data from the received output data; and analyzing the anti-drone product by using the extracted text data.

The connecting of the edge computing device to the anti-drone product includes: receiving a communication connection request when connected to a physical interface of the anti-drone product; confirming information on the anti-drone product requesting the connection; confirming a communication connection method of the confirmed anti-drone product; connecting to the anti-drone product through the confirmed communication connection method and receiving output data from the anti-drone product; marking a timestamp according to global time synchronization on the output data received from the anti-drone product; and terminating the reception of the output data from the anti-drone product.

The analyzing of the output data of the anti-drone product includes: retrieving a time data schema; receiving the output data from the anti-drone product; refining the received output data; selecting output data to be analyzed from the refined output data; packaging the selected output data; and transmitting the packaged output data.

In the receiving of the output data from the anti-drone product, output data are collected after connecting to a plurality of anti-drone products, and the collected output data are marked on a timestamp according to global time synchronization and stored.

The present disclosure further includes: attaching an environmental sensor to an exterior of the anti-drone product in order to collect external environment information when a function of the anti-drone product is performed; and collecting the external environment information by the environmental sensor when the function of the anti-drone product is performed and transmitting the collected information to the edge computing device via a communication interface.

An anti-drone analysis system according to an aspect of the present disclosure includes: a target aircraft configured to fly over an anti-drone test site area according to a received flight scenario of the target aircraft during anti-drone verification; a ground control station configured to transmit the flight scenario to the target aircraft; an anti-drone product configured to perform an anti-drone function on the target aircraft flying over the anti-drone test site area, and to provide log information stored when the anti-drone function is performed; an edge computing device configured to receive output data including the log information from the anti-drone product when connected to the anti-drone product, to extract text data from the received output data, to add a global timestamp value to the extracted text data, and to analyze the text data based on the added global timestamp value; and an anti-drone verification server configured to verify performance of the anti-drone product based on the text data.

The edge computing device includes a plurality of communication interfaces for connecting to a plurality of anti-drone products, and marks a plurality of collected output data collected through the plurality of communication interfaces on a timestamp according to global time synchronization, and stores the plurality of marked output data.

The edge computing device determines performance differences between anti-drone devices when analyzing the text data based on the global timestamp value.

In a case of receiving a communication connection request when connecting to the anti-drone product or connecting to a physical interface of the anti-drone product, the edge computing device confirms information of the anti-drone product requesting the connection and a communication connection method with the anti-drone product by using information stored in a database, and connects to the anti-drone product through the confirmed communication connection method.

The edge computing device retrieves a time data schema, receives output data from the anti-drone product, refines the received output data, and selects and packages output data.

The edge computing device further includes an environmental sensor attached to an exterior of the anti-drone product to collect operating data of the anti-drone product during an execution of an anti-drone function and environment data outside the anti-drone product.

The present disclosure can evaluate functions and performance by minimizing modification to an already developed anti-drone product and connecting an edge computing system device.

In addition, the present disclosure can perform evaluation more objectively by analyzing data based on log or output data of each anti-drone produce to minimize an influence of a subsystem in an anti-drone verification system.

In addition, the present disclosure can minimize human errors and enhance the objectivity of test and verification by automatically collecting operating environment data on an anti-drone products.

### BRIEF DESCRIPTION OF THE DRAWINGS

FIG. 1 is an embodiment diagram for explaining an anti-drone verification system according to an embodiment of the present disclosure.

FIG. 2 is a block diagram illustrating a configuration of an edge computing device in an anti-drone verification system according to an embodiment of the present disclosure.

FIG. 3 is a diagram illustrating the flow of signals between an anti-drone product and an edge computing device in the anti-drone verification system according to an embodiment of the present disclosure.

FIG. 4 is a diagram illustrating the flow of signals between an anti-drone product and an edge computing device in an anti-drone verification system according to another embodiment of the present disclosure.

FIG. 5 is a flowchart for explaining an anti-drone verification method according to an embodiment of the present disclosure.

FIG. 6 is a diagram illustrating the flow of signals for explaining a method for collecting output data of an anti-drone product in an anti-drone verification method according to an embodiment of the present disclosure.

FIG. 7 is a diagram illustrating the flow of signals for explaining a method for analyzing output data of an anti-drone product in an anti-drone verification method according to an embodiment of the present disclosure.

### DETAILED DESCRIPTION

The advantages and characteristics of the present disclosure and a method for achieving them will become apparent from the embodiments described in detail below in conjunction with the accompanying drawings. However, the present disclosure is not limited to the disclosed embodiments to be disclosed below, but will be implemented in various different forms. The embodiments below are nothing but the ones provided to bring the disclosure of the present disclosure to perfection and assist those skilled in the art to which the present disclosure pertains to completely understand the scope of the present disclosure. The present disclosure is defined only by the scope of the appended claims. Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements, steps, operations, and/or elements in addition to a mentioned element, step, operation, and/or element.

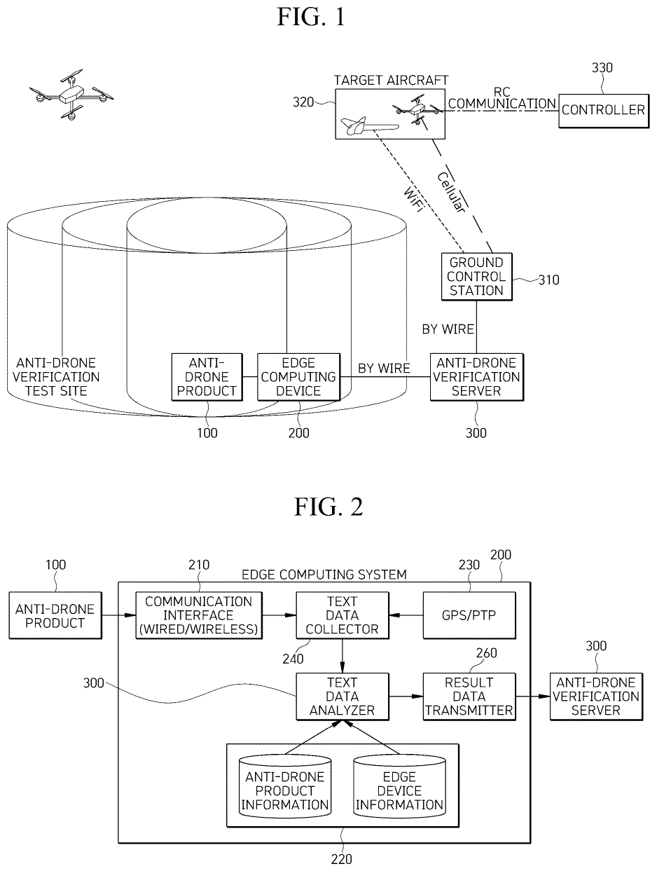

As illustrated in FIG. 1, an anti-drone verification system may include an anti-drone product 100, an edge computing device 200, an anti-drone verification server 300, a ground control station 310, and a target aircraft 320.

Therefore, a user operates the target aircraft 320 through a controller 330, and performs an anti-drone function on the operating target aircraft 320 through the anti-drone product.

In this way, data of the anti-drone product performing the anti-drone function is automatically collected and analyzed.

An anti-drone analysis system according to an embodiment of the present disclosure includes: a target aircraft configured to fly over an anti-drone test site area according to a received flight scenario of the target aircraft during anti-drone verification; a ground control station configured to transmit the flight scenario to the target aircraft; an anti-drone product configured to perform an anti-drone function on the target aircraft flying over the anti-drone test site area, and to provide log information stored when the anti-drone function is performed; an edge computing device configured to receive output data including the log information from the anti-drone product when connected to the anti-drone product, to extract text data from the received output data, to add a global timestamp value to the extracted text data, and to analyze the text data based on the added global timestamp value; and an anti-drone verification server configured to verify performance of the anti-drone product based on the text data.

The edge computing device includes a plurality of communication interfaces for connecting to a plurality of anti-drone products, and marks a plurality of collected output data collected through the plurality of communication interfaces on a timestamp according to global time synchronization, and stores the plurality of marked output data.

The edge computing device determines performance differences between anti-drone devices when analyzing the text data based on the global timestamp value.

In a case of receiving a communication connection request when connecting to the anti-drone product or connecting to a physical interface of the anti-drone product, the edge computing device confirms information of the anti-drone product requesting the connection and a communication connection method with the anti-drone product by using information stored in a database, and connects to the anti-drone product through the confirmed communication connection method.

The edge computing device retrieves a time data schema, receives output data from the anti-drone product, refines the received output data, and selects and packages output data.

The edge computing device further includes an environmental sensor attached to an exterior of the anti-drone product to collect operating data of the anti-drone product during an execution of an anti-drone function and environment data outside the anti-drone product.

Hereinafter, preferred embodiments of the present disclosure are described in detail with reference to the accompanying drawings. FIG. 2 is a block diagram for explaining an edge computing system for anti-drone system analysis according to an embodiment of the present disclosure.

As illustrated in FIG. 2, the edge computing system for anti-drone system analysis according to an embodiment of the present disclosure includes the anti-drone product 100 and the edge computing device 200.

The anti-drone product 100 performs one or more of drone detection, identification, and neutralization functions, and collects log data in order to collect information (radio wave intensity, wireless signal intensity, latitude, longitude, altitude, angle, and direction) necessary for performing the anti-drone function. When the anti-drone product 100 does not have a separate function of outputting log data, this can be implemented by installing a separate program called agent 120 within the product. The agent 120 can collect various data output from the anti-drone product 100 through a function of intercepting standard output (stdout)/standard error (stderr) logs provided by an operating system (OS) (Linux or Windows) of the anti-drone product 100 according to the characteristics of the operating system. The agent 120 can also monitor file logs managed by the operating system or the anti-drone product 100 itself.

The anti-drone product 100 may be provided with one or more devices among a radar that uses radio waves to detect and track the location, speed, altitude, etc., of a drone, a radio frequency (RF) scanner that detects radio signals between the drone and a controller to ascertain the presence of the drone and track the flight direction of the drone, an optical/infrared (EO/IR) camera used to visually confirm and identify a target detected by the radar or the RF scanner, an optical camera, a thermal imaging camera, and an acoustic sensor that senses the sound of the drone.

The anti-drone product 100 may have functions such as soft kill for neutralizing functions of a drone without causing physical damage to the drone: including radio jamming that disrupts GPS, communication frequencies, etc., of the drone to make the drone uncontrollable or forcibly land the drone; spoofing that transmits fake GPS signals to induce the drone to return to the original location or land elsewhere; and drone hunter that uses other drones to capture and retrieve illegal drones with nets; and hard kill for physically destroying the drone such as high-powered laser that burns out critical components of the drone with laser and cause the drone to crash; and missiles or rifles that directly shoot down the drone with small missiles or guns.

The anti-drone product 100 includes a communication interface 110 and the agent 120.

The communication interface 110 is a physical interface for connecting to the edge computing device 200. For example, the communication interface 110 supports wired and wireless communication and can be connected via serial communication, wired/wireless Ethernet communication, Bluetooth communication, etc. The serial communication can be performed via RS232 or RS485. For the serial connection, software that allows the anti-drone product 100 to output various log data via a serial port is required within the anti-drone product 100. The software can be integrated into codes already written in a product or run through separate software.

In the case of the wired/wireless Ethernet connection, data is received when connected to the same Ethernet band via a WiFi AP, an Ethernet switch, etc. Settings in which the anti-drone product 100 can transmit various log data via Ethernet communication are required in the anti-drone product 100. Various applications, such as API call, MQTT, and DBMS, can be applied to a method for transmitting data via Ethernet.

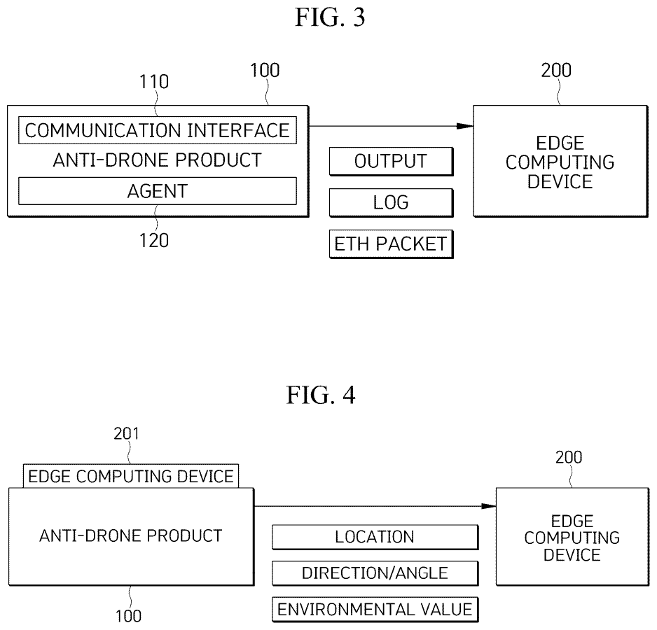

As illustrated in FIG. 3, the agent 120 copies standard output/standard error log data (output, log, ETH packet) provided by an operating system (OS) of the anti-drone product 100 according to the characteristics of the operating system and then provides output data including the log data to the edge computing device 200 via the communication interface 110. Preferably, the log data is in text format.

The edge computing device 200 is connected to the anti-drone product 100 via the physical communication interface 210, receives the output data, extracts text data from the received output data, and analyzes text data obtained by adding a global timestamp value to the extracted text data. Preferably, the text data is data regarding the operation and performance of the anti-drone product. As illustrated in FIG. 2, the edge computing device 200 includes a physical communication interface 210, a database 220, a GPS/PTP 230, a text data collector 240, and a text data analyzer 250.

The physical communication interface 210 is connected to the communication interface 110 of the anti-drone product 100. The physical communication interface 210 is a physical interface for connecting to the anti-drone product 100. For example, the physical communication interface 210 supports wired and wireless communication and can be connected via serial communication, wired and wireless Ethernet communication, Bluetooth communication, etc. The serial communication can be performed via RS232 or RS485. For the serial connection, software that allows the anti-drone product 100 to output various log data via a serial port is required within the anti-drone product 100. The software can be integrated into codes already written in a product or run through separate software.

The database 220 stores edge device information including information on the anti-drone product 100 regarding functions according to functional purposes (carrying and identification and neutralization) of the anti-drone product 100, and network information (reception-side information).

The GPS/PTP 230 acquires the global timestamp value of an anti-drone analysis system.

The text data collector 240 collects text data from the information on the anti-drone product 100 received via the communication interface 210, and converts the collected text data into data in a preset data format. The text data collector 240 acquires the global timestamp value of the anti-drone analysis system acquired via GPS or a PTP protocol, matches the global timestamp value to various event data collected during drone detection, identification, and neutralization, and objectively stores the time of the data.

Subsequently, the text data collector 240 acquires a method for interpreting the collected data of the anti-drone product 100 from the anti-drone information stored in the database 220, and interprets log data and various output data based on the method. Text data output from the anti-drone product may include code-based information (e.g., 1001: normal, 1002: error, etc.), may be written in natural language, or may be expressed as structured data (e.g., code: 0000, status: 0000, time: 000), and can be freely interpreted. The text data output from the anti-drone product can be implemented with general program codes or by utilizing an artificial intelligence model that interprets natural language such as LLM.

The text data analyzer 250 analyzes the text data by using the anti-drone information stored in the database 220.

The text data analyzer 250 selects important data related to the functions and performance of the anti-drone product 100 according to the functional purposes (detection, identification, and neutralization) from the collected data, converts the data by referring to a data format required by the anti-drone verification server and stored in the database 220, and transmits the data, including network information (reception-side information) defined in the database 220, to a result data transmitter 260.

The data transmitter 260 transmits the processed data to the anti-drone verification server 300 being a recipient. When the anti-drone verification server is physically and functionally separate, the processed data can be transmitted to a plurality of recipients.

On the other hand, the edge computing device 200 may further include an environmental sensor 201 attached to the exterior of the anti-drone product 100 to collect operating data (location, longitude, altitude, angle, and direction) and environment data (temperature/humidity) of the anti-drone product 100. Such an environmental sensor 201 is connected to the edge computing device 200 via the communication interface 110.

That is, by separately attaching the environmental sensor 201 for collecting the operating environment data of the communication interface 110 to the exterior of the anti-drone product 100, the environmental sensor 201 can automatically collect the operating environment data (temperature/humidity) of the anti-drone product 100 and the operating position data (latitude, longitude, altitude, angle, and direction) of the anti-drone product 100, and transmit the collected data to the edge computing device 200. This allows objective data on the operating environment of the anti-drone product 100 to be acquired and transmitted to the anti-drone verification server 300, thereby minimizing manual data input by a tester and enabling the collection of more objective data.

By configuring the environmental sensor 201 within the edge computing device 200 and attaching the edge computing device 200 to the anti-drone product 100, as illustrated in FIG. 4, operating position data can be collected, or the environmental sensor 201 can be implemented in various forms in consideration of the external appearance of the anti-drone product 100 and implemented as a separate device.

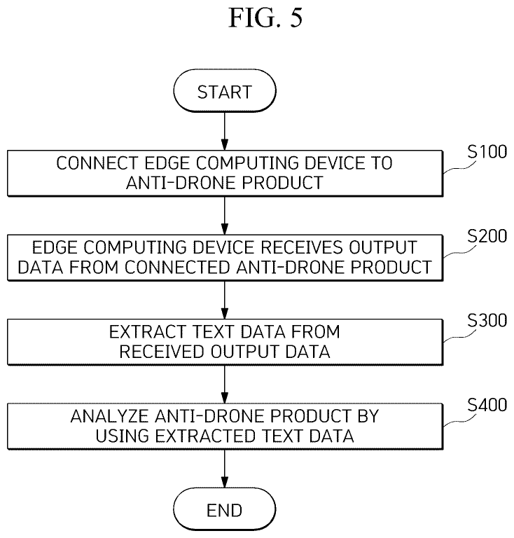

Hereinafter, an edge computing method for analyzing an anti-drone system according to another embodiment of the present disclosure is described with reference to FIG. 5.

First, the edge computing device 200 is connected to the anti-drone product 100 (S100).

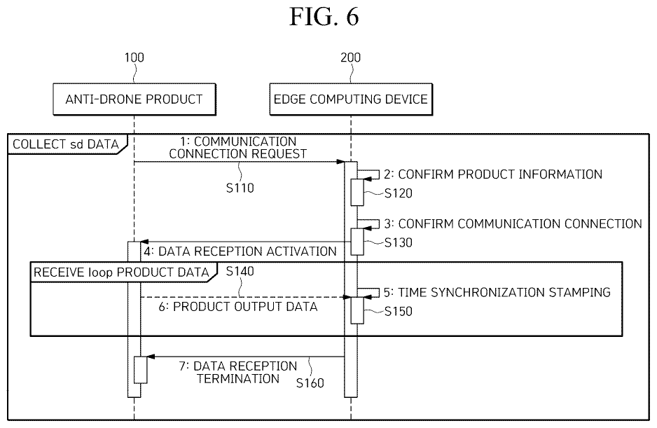

The step S100 of connecting the edge computing device 200 to the anti-drone product 100 is described below with reference to FIG. 6.

When connecting to the physical interface of the anti-drone product 100, the edge computing device 200 receives a communication connection request (S110).

The edge computing device 200 confirms information on the anti-drone product 100 requesting the connection (S120).

Subsequently, the edge computing device 200 confirms the communication connection method of the confirmed anti-drone product 100 (S130).

Subsequently, the edge computing device 200 is connected to the anti-drone product 100 via the confirmed communication connection method, and receives output data of the anti-drone product 100 (S140).

Subsequently, the edge computing device 200 marks a timestamp according to global time synchronization on the output data received from the anti-drone product 100 (S150).

Subsequently, the edge computing device 200 terminates the reception of the output data from the anti-drone product 100 (S160).

The edge computing device 200 receives output data from the connected anti-drone product 100 (S200).

Subsequently, the edge computing device 200 extracts text data from the received output data (S300).

Subsequently, the edge computing device 200 analyzes the anti-drone product 100 by using the extracted text data (S400).

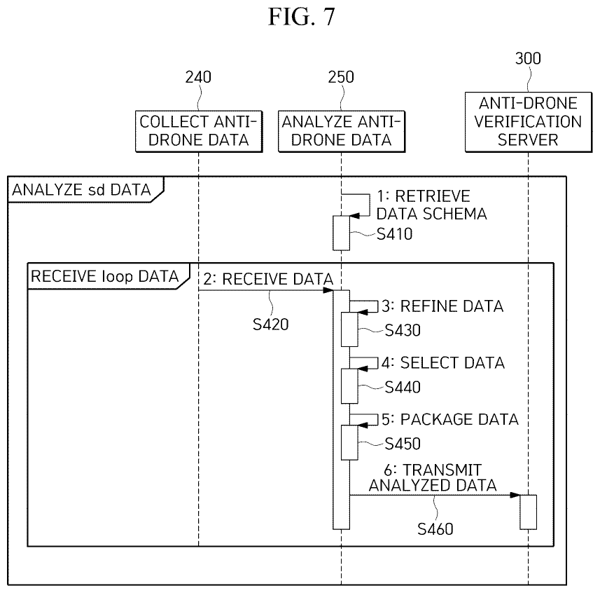

The step S400 of analyzing the output data of the anti-drone product 100 is described with reference to FIG. 7.

First, the edge computing device 200 retrieves a time data schema (S410).

Subsequently, the edge computing device 200 receives the output data of the anti-drone product 100 (S420).

Subsequently, the edge computing device 200 refines the received output data (S430), and selects output data to be analyzed from the refined output data (S430).

Subsequently, the edge computing device 200 packages the selected output data (S440), and transmits the packaged output data.

On the other hand, the step S100 of connecting the edge computing device 200 to the anti-drone product 100 may include a step of attaching (S101) the environmental sensor 201 to the exterior of the anti-drone product 100 in order to collect external environment information when the function of the anti-drone product 100 is performed, and then collecting external environment information by the environmental sensor 201 when the function of the anti-drone product 100 is performed and transmitting (S102) the collected information to the edge computing device 200 via the communication interface 110.

Each step included in the method described above may be implemented as a software module, a hardware module, or a combination thereof, which is executed by a computing device.

Also, an element for performing each step may be respectively implemented as first to two operational logics of a processor.

The devices, apparatuses, units, modules, and components described herein with respect to FIGS. 1-4D are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application, and illustrated in FIGS. 3-7, are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that be performed by the hardware components and the methods as described above. In one example, the instructions or software include machine code that is directly executed by the one or more processors or computers, such as machine code produced by a compiler. In another example, the instructions or software include higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), EEPROM, RAM, DRAM, SRAM, flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors and computers so that the one or more processors and computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

Although the configuration of the present disclosure has been described in detail with reference to the accompanying drawings, this is merely an example, and those skilled in the art to which the present disclosure pertains can make various modifications and changes within the scope of the technical spirit of the present disclosure. Therefore, the scope of protection of the present disclosure should not be limited to the above-described embodiments and should be defined by the description of the appended claims.

What is claimed is:

1. An edge computing device comprising:
a physical communication interface connected to a communication interface of an anti-drone product; and
a text data collector configured to connect to the anti-drone product, to receive output data from the connected anti-drone product, to extract text data from the received output data of the anti-drone product, and to convert the extracted text data into data in a preset data format.

2. The edge computing device of claim 1, further comprising:
a database configured to store edge device information including information on the anti-drone product regarding functions according to functional purposes (carrying and identification and neutralization) of the anti-drone product, and network information (reception-side information); and
a timestamp acquisition unit configured to acquire a global timestamp value for an anti-drone analysis,
wherein the text data collector acquires a global timestamp value of an anti-drone analysis system acquired via GPS or a PTP protocol, matches the global timestamp value to various event data collected during drone detection, identification, and neutralization, and objectively stores time of the data.

3. The edge computing device of claim 1, further comprising:
an environmental sensor attached to an exterior of the anti-drone product to collect operating data of the anti-drone product during an execution of an anti-drone function and environment data outside the anti-drone product.

4. The edge computing device of claim 1, wherein the communication interface is provided in a plural number to be connected in parallel to a plurality of anti-drone products, and
text data collectors store data collected from the plurality of anti-drone products via respective communication interfaces in an integrated manner based on a global timestamp value.

5. The edge computing device of claim 1, wherein an anti-drone product configured to perform an anti-drone function is provided and comprises:
a communication interface configured to communicate with the edge computing device; and
an agent configured to copy standard output/standard error log data provided by an operating system (OS) of the anti-drone product according to characteristics of the operating system, and to transmit output data including the log data to the edge computing device via the communication interface.

6. The edge computing device of claim 5, wherein the anti-drone product is one or more devices among a radar that uses radio waves to detect and track a location, speed, and altitude of a drone, a radio frequency (RF) scanner that detects radio signals between the drone and a controller to ascertain presence of the drone and track a flight direction of the drone, an optical/infrared (EO/IR) camera used to visually confirm and identify a target detected by the radar or the RF scanner, an optical camera, a thermal imaging camera, and an acoustic sensor that senses sound of the drone.

7. An anti-drone analysis method comprising:
connecting an edge computing device to an anti-drone product;
receiving, by the edge computing device, output data from the connected anti-drone product;
extracting text data from the received output data; and
analyzing the anti-drone product by using the extracted text data.

8. The anti-drone analysis method of claim 7, wherein the connecting of the edge computing device to the anti-drone product comprises:
receiving a communication connection request when connected to a physical interface of the anti-drone product;
confirming information on the anti-drone product requesting the connection;
confirming a communication connection method of the confirmed anti-drone product;
connecting to the anti-drone product through the confirmed communication connection method and receiving output data from the anti-drone product;
marking a timestamp according to global time synchronization on the output data received from the anti-drone product; and
terminating the reception of the output data from the anti-drone product.

9. The anti-drone analysis method of claim 7, wherein the analyzing of the output data of the anti-drone product comprises:
retrieving a time data schema;
receiving the output data from the anti-drone product;
refining the received output data;
selecting output data to be analyzed from the refined output data;
packaging the selected output data; and
transmitting the packaged output data.

10. The anti-drone analysis method of claim 9, wherein, in the receiving of the output data from the anti-drone product, output data are collected after connecting to a plurality of anti-drone products, and the collected output data are marked on a timestamp according to global time synchronization and stored.

11. The anti-drone analysis method of claim 7, further comprising:
attaching an environmental sensor to an exterior of the anti-drone product in order to collect external environment information when a function of the anti-drone product is performed; and
collecting the external environment information by the environmental sensor when the function of the anti-drone product is performed and transmitting the collected information to the edge computing device via a communication interface.

12. An anti-drone analysis system comprising:
a target aircraft configured to fly over an anti-drone test site area according to a received flight scenario of the target aircraft during anti-drone verification;
a ground control station configured to transmit the flight scenario to the target aircraft;
an anti-drone product configured to perform an anti-drone function on the target aircraft flying over the anti-drone test site area, and to provide log information stored when the anti-drone function is performed;
an edge computing device configured to receive output data including the log information from the anti-drone product when connected to the anti-drone product, to extract text data from the received output data, to add a global timestamp value to the extracted text data, and to analyze the text data based on the added global timestamp value; and
an anti-drone verification server configured to verify performance of the anti-drone product based on the text data.

13. The anti-drone analysis system of claim 12, wherein the edge computing device includes a plurality of communication interfaces for connecting to a plurality of anti-drone products, and
marks a plurality of collected output data collected through the plurality of communication interfaces on a timestamp according to global time synchronization, and stores the plurality of marked output data.

14. The anti-drone analysis system of claim 12, wherein the edge computing device determines performance differences between anti-drone devices when analyzing the text data based on the global timestamp value.

15. The anti-drone analysis system of claim 12, wherein, in a case of receiving a communication connection request when connecting to the anti-drone product or connecting to a physical interface of the anti-drone product, the edge computing device confirms information of the anti-drone product requesting the connection and a communication connection method with the anti-drone product by using information stored in a database, and
connects to the anti-drone product through the confirmed communication connection method.

16. The anti-drone analysis system of claim 15, wherein the edge computing device retrieves a time data schema, receives output data from the anti-drone product, refines the received output data, and selects and packages output data.

17. The anti-drone analysis system of claim 14, wherein the edge computing device further comprises:
an environmental sensor attached to an exterior of the anti-drone product to collect operating data of the anti-drone product during an execution of an anti-drone function and environment data outside the anti-drone product.
